(19) United States
(12) Patent Application Publication
(10) Pub. No.: US 2007/0012827 A1
(43) Pub. Date: Jan. 18, 2007

(54) Portable support device

(76) Inventors: Pinde Fu, Highland, CA (US); Jun Liu, Highland, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/182,225

(22) Filed: Jul. 15, 2005

(51) Int. Cl. F16M 11/32

(52) U.S. Cl. 248/163.1

(57) ABSTRACT

A portable support device is described for holding a laptop computer, other electronic device, book or notebook, or other load object on a tiltable support board for viewing and operation by a person situated in any of a variety of body positions, including, but not limited to sitting, lying, and reclining in a variety of indoor and outdoor locations. The tiltable support board may accordingly be positioned and locked into a variety of angular inclinations with respect to a structure of the portable support device while the laptop computer or other load is securely displayed to the situated user, who may be sitting or lying under the device. In a preferred embodiment, the portable support device also comprises a set of legs that are independently extendable and independently angularly positionable in order to allow for use on a variety of uneven surfaces, including beds, couches, and uneven outdoor locations.

### FIELD OF THE INVENTION

The invention relates to support devices for holding laptop computers, books, and the like for use by people in a variety of positions, including standing, sitting, reclining, or lying supine.

### BACKGROUND OF THE INVENTION

Laptop computers and other telecommunications and electronic media devices are becoming increasingly portable, powerful, and affordable. Not surprisingly, the popularity of such devices has skyrocketed, as has the desire to rely on them increasingly for work, entertainment, and other purposes in a variety of traditional and non-traditional locations. For example, users may desire to surf the Internet, watch DVD movies, or compose documents as they lie in a comfortable position that supports their neck and head while in bed or in outdoor settings. Using these devices while sitting, reclining, or lying supine requires that the device be supported in an appropriate position to be viewable and operable by the user. Similarly, readers who wish to view books, magazines or other such non-electronic materials in these positions in indoor and outdoor settings face similar challenges.

Currently existing stands of this type generally can be categorized into several different categories. First, there are desktop stands that are adapted to be positioned on top of desks. Second, there are also stands that are adapted to be mounted on the ground so as to extend over a bed, typically with the feet of the stand extending underneath the bed to allow a person sitting in bed to make use of the stand. These types of stands are large and not very portable. Third, there are in bed reading tables which often are insufficiently stable for convenient use with portable electronic devices.

Accordingly, a wide variety of stands have been developed to hold a laptop computer, other electronic device, or book in a position to be used by a person in a reclining or supine position. Such stands typically comprise a table portion for appropriately supporting the laptop or book and legs that are configured to support the table portion while the user reclines or lies supine. The stand's table portion and legs may be of a static configuration or may be adjustable, especially with regard to the tilt of the table portion and length of the legs.

However, what the existing stands fail to take into account is the very common situation that the surface on which the user is lying may not be flat and/or may not be solid enough to provide uniform support to the legs of stand. This is especially unfortunate for stands that are otherwise easily portable, because such stands may induce a user to believe that they are usable “anywhere,” whereas their use in many common settings may prove problematic.

For example, users who choose to read, view, or work while in bed need a device that can reliably support their book or laptop device, no matter the surface. Hospital patients need a support device that will accommodate the presence of casts, other equipment, cushions, and the like on the bed as well as the existence of other special circumstances that may not allow for a solid, uniform, flat surface on which to support the stand. Users who share a bed with another person may desire a support device whose legs can comfortably accommodate the other person. Users who wish to use their devices or read a book while lying outdoors may encounter problems if their chosen spot does not have a solid and uniformly flat surface on which to reliably support the legs of currently available stands. Moreover, the legs of the existing support devices are usually fixed and oriented such that a person using the support has to use the device while lying on their back. This represents an inconvenience for users who wish to use a stand while lying on their side.

All of these common situations point to a need for a more adjustably supported stand for reliably holding a laptop, other electronic device, or book in a variety of positions.

### SUMMARY OF THE INVENTION

A portable support device is described for holding a laptop computer, other electronic device, book or notebook, or other load object on a tiltable support board for viewing and operation by a person situated in any of a variety of body positions, including, but not limited to sitting, lying, and reclining in a variety of indoor and outdoor locations. The tiltable support board may accordingly be positioned and locked into a variety of angular inclinations with respect to a structure of the portable support device while the laptop computer or other load is securely displayed to the situated user, who may be sitting or lying under the device. In a preferred embodiment, the portable support device also comprises a set of legs that are independently extendable and independently angularly positionable in order to allow for use on a variety of uneven surfaces, including beds, couches, and uneven outdoor locations.

Neither this summary nor the following detailed description defines the invention. The invention is defined by the claims.

### BRIEF DESCRIPTION OF THE DRAWINGS

A general architecture that implements various features of specific embodiments of the invention will now be described with reference to the drawings. The drawings and the associated descriptions are provided to illustrate embodiments of the invention and not to limit the scope of the invention. Throughout the drawings, reference numbers are re-used to indicate correspondence between referenced elements.

FIG. 1 depicts an example of a person using one embodiment of the portable support device with a laptop computer while lying down.

FIG. 2 depicts a perspective view of one embodiment of the portable support device.

FIG. 3 depicts a front view of one embodiment of the portable support device with its top in a vertical position.

FIG. 4 depicts a side view of one embodiment of the portable support device with its top in a tilted position.

FIG. 5A provides a more detailed front view of one embodiment of a gear wheel and a position-locking mechanism.

FIG. 5B provides a more detailed cross-section view of one embodiment of the gear wheel and the position-locking mechanism.

FIG. 6 provides a more detailed view of the internal structure of one embodiment of the position-locking mechanism.

FIG. 7 provides a more detailed view of one embodiment of a leg and attached hinge mechanism

FIG. 8A provides a more detailed view of a second embodiment of a tilting mechanism for the tiltable support board in a tilted position.

FIG. 8B provides a more detailed view of the second embodiment of a tilting mechanism for the tiltable support board in a vertical position

FIG. 9 provides a more detailed view of a third embodiment of a tilting mechanism for the tiltable support board

### DETAILED DESCRIPTION OF THE PREFERRED EMBODIMENT

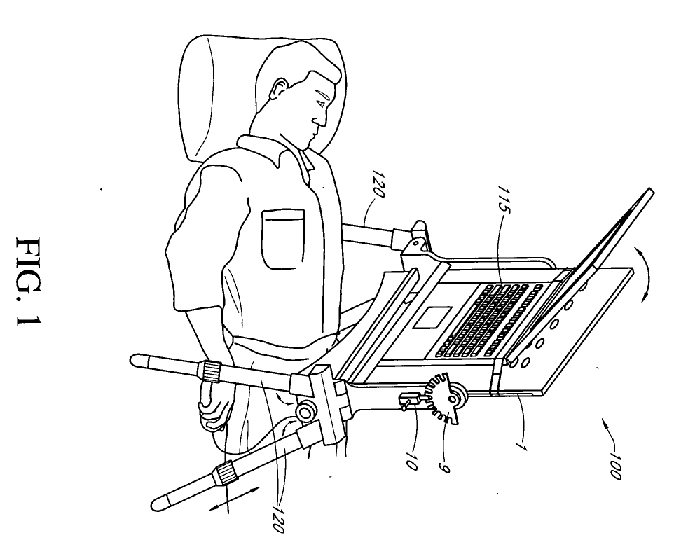

FIG. 1 depicts an example of a person using one embodiment of the portable support device 100 with a laptop computer 115 while lying down on their back or sides. As depicted in FIG. 1, the person is lying supine, while the portable support device 100 straddles the person's body and a tiltable support board 1 supports the laptop computer 115 in a position that is viewable by the person in the supine position. The portable support device 100 includes a plurality of adjustable legs 120, for example, four adjustable legs 120, that may be individually adjusted with respect to their length and/or their angular relationship to the portable support device 100, so that the portable support device 100 and the laptop computer 115 are stably supported on a surface that may not be uniformly flat and supportive.

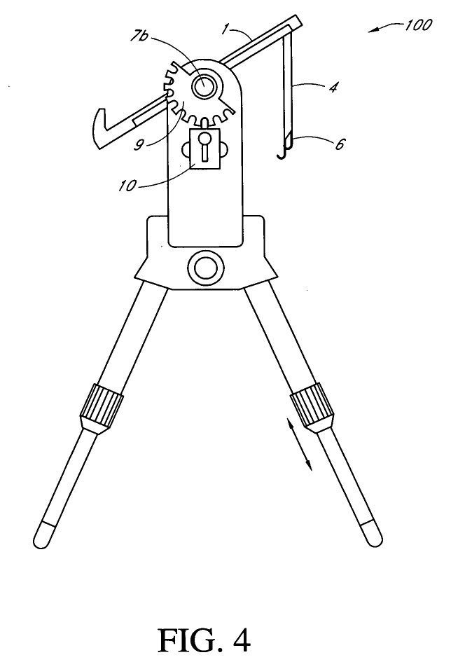

The embodiment of the portable support device 100 depicted in FIG. 1 also comprises a gear wheel 9 and a position-controlling mechanism 10 for supporting the laptop computer 115 in a desired tilted or non-tilted position with respect to the person using the laptop 115, as will be described in greater detail with reference to FIG. 4-6.

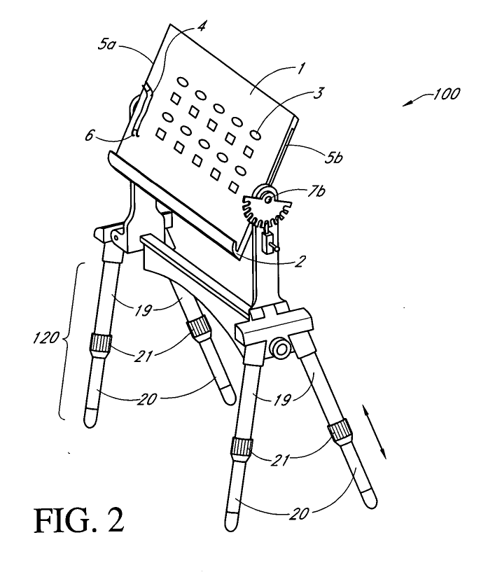

FIG. 2 depicts a perspective view of one embodiment of the portable support device 100 without a laptop computer or other electronic device or book being supported by the portable support device 100. The tiltable support board 1 for supporting the laptop computer 115 or other electronic device or book includes a plurality of holes 3 that advantageously provide ventilation and protection overheating for an electronic device being supported on the tiltable support board 1. In various embodiments, the holes 3 may be sized and configured as desired or may not be employed.

In preferred embodiments, an axle, one end 7b of which is viewable in FIG. 2, runs through the tiltable support board 1, and the tiltable support board 1 can be rotated into any of a variety of angular positions about the axle. For example, in FIG. 2, the tiltable support board 1 is positioned at an angle of approximately 30° with respect to a vertical, fully upright position.

In the embodiment shown in FIG. 2, two rectangular loops 5a, 5b, which may be made of metal, plastic, or other suitable material, are attached to left and right sides of the tiltable support board 1. One or more elastic straps 4 are used to secure the laptop computer 115 or other electronic device or book to the tiltable support board 1 in the manner shown in FIG. 1. In one embodiment, a first end of each elastic strap 4 is attached to a first of the two rectangular loops 5a, 5b. A second end of each elastic strap 4 is attached to a hook 6. The one or more elastic straps 4 may be stretched across a laptop computer 115 or other electronic device or book that is being supported on the tiltable support board 1, and the hook 6 of each such elastic strap 4 may be hooked onto a second of the two rectangular loops 5a, 5b. Thus, the laptop computer 115 or other electronic device or book is secured up against the tiltable support board 1, even as the tiltable support board 1 is tilted into a variety of positions. In various embodiments, the elastic strap 4 and hook 6 may be attached to the rectangular loops 5a, 5b at various points along the length of the rectangular loops 5a, 5b, or may be slid along the rectangular loops 5a, 5b, in a manner that allows the elastic strap 4 to accommodate loads of various sizes.

In other embodiments, the laptop computer 115 or other electronic device or book may be secured against the tiltable support board 1 using any one or more of a variety of other methods and devices. As one example, the holes 3 also provide additional locations for inserting and/or otherwise securing straps, hooks, or other attaching devices for ensuring that a device or object being supported by the portable support device 100 will stay in place against the tiltable support board 1, no matter the angle at which the tiltable support board is positioned. It will thus be appreciated that any of a number of ways of securing the computer or other electronic device to the support board 1 may be employed without departing from the spirit of the present invention.

The tiltable support board 1 further includes a lower ledge 2 that supports a bottom portion of the laptop computer 115 or other electronic device or book. In one embodiment, the lower ledge 2 includes a lip, as can be seen in FIG. 2 and FIG. 4, that provides extra security for holding the laptop computer 115 or other electronic device or book securely in place as the tiltable support board 1 is tilted. In other embodiments, the lower ledge 2 does not include a lip, or includes a more open lip, so that the lower ledge 2 can securely accommodate laptop computers 115, other electronic devices, or books of varying thicknesses. In one implementation, the lip is an open lip that extends substantially perpendicular to the plane of the surface or is otherwise tapered outward in the manner shown such that computers or other portable electronic devices of different thicknesses can be accommodated.

FIG. 2 further shows the legs of the portable support device 100. Each leg includes a first or upper leg portion 19, a second or lower leg portion 20, and an adjustable locking portion 21. The adjustable locking portion 21 tightens or loosens as it is twisted clockwise or counterclockwise, thereby respectively locking the upper leg portion 19 and the lower leg portion 20 in position with respect to one another, or allowing the upper leg portion 19 and the lower leg portion 20 to slideably move with respect to one another. In a preferred embodiment, the upper leg portion 19 is hollow, and in order to shorten the leg, the adjustable locking portion 21 may be loosened, allowing the lower leg portion 20 to be inserted up into a hollow cavity or other suitable space inside the upper leg portion 19. The adjustable locking portion 21 may then be twisted in order to lock the lower leg portion 20 in place. While in this implementation, the legs are described as having two sections or portions, e.g., the upper leg portion 19 and the lower leg portion 20 that telescope with respect to each other, a person of ordinary skill in the art can appreciate that multiple portions e.g., more than two portions, can also be used in this implementation to provide for even greater flexibility with respect to the height of the device without departing from the spirit of the present invention.

Thus, the legs of the portable support device 100 may be adjusted, easily and independently from one another, to a height that is desirable for each leg, given the characteristics of the surface upon which the portable support device 100 is situated at any time. In other embodiments, the adjustable locking portion 21 may be embodied as a knob, bolt, nut, snap, other push-fastener, fastener ring, or other suitable adjustable locking mechanism.

As each of the legs 120 are thus independently extendable, the legs can be extended so as to accommodate uneven surfaces. For example, if the user is making use of the device 100 in a bed, the bed covers, pillows and mattresses can create a very uneven surface such that the device would otherwise be unstable. The user can, however, with the instant device extend the legs 120 downward, as well as pivoting the legs 120 outward from the platform 1 so as to ensure that the platform is stable enough to allow a user to type on the laptop or notebook computer 115 secured thereto.

It will be appreciated that since the legs 120 are independently adjustable, legs on one side can be adjusted much higher than legs on another side to thereby tilt the support device. This will allow a person to lie on their side and still have their hips or legs positioned beneath the support stand and still allow the user to reach and see the support platform.

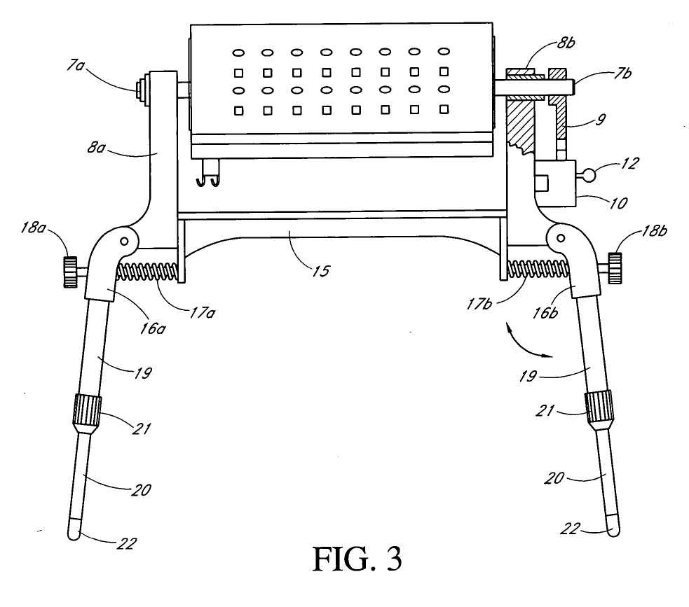

FIG. 3 depicts a more detailed front view of one embodiment of the portable support device 100 with its tiltable support board 1 in an upright, vertical position. As can be seen in FIG. 3, the axle 7, with ends 7a, 7b, runs through holes in two vertical posts 8a, 8b on either side of the tiltable support board 1. The axle is rotatable with respect to the holes in the two vertical posts 8a, 8b, thus allowing the tiltable support board 1 to be rotated about the axle. After passing through one of the vertical posts 8b, at least one end of the axle 7b also passes though a gear wheel 9, for adjusting and securing the tiltable support board 1 in a selected position, as will be described in greater detail with reference to FIGS. 4-6

The vertical posts 8a, 8b are attached, near their bottom, to a horizontal beam 15 that provides structural integrity to the portable support device 100. The vertical posts 8a, 8b are further attached, hingeably, to hinge mechanisms 16a, 16b, each of which is attached to an upper leg portion 19. In one embodiment, the upper legs portions 19 may be removed, for example, by unscrewing threaded portions at the top of the upper leg portions 19, from the hinge mechanisms 16a, 16b, for easy and efficient packing and transporting of the portable support device 100, which can thereby be configured to take up very little space and be less prone to sustaining damage to protruding parts.

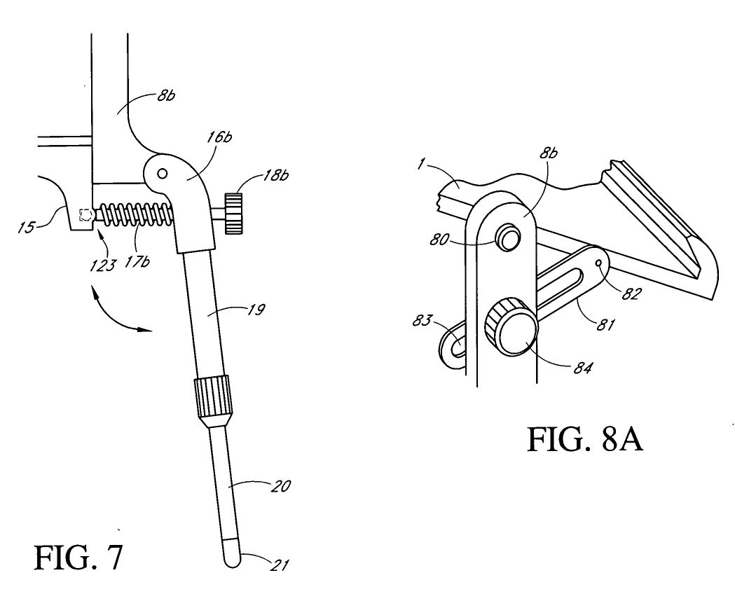

In one embodiment, as depicted in FIG. 3 and FIG. 7, two width controller knobs 18a, 18b, shaped and sized to be easily manipulated by hand, are each attached to a rod or bolt that runs through the hinge mechanism 16a, 16b and a spring 17a, 17b before contracting to a lateral portion of the horizontal beam 15. As is illustrated in FIG. 7, at the point where the rod or bolt contacts the lateral beam 15, the bolt or rod engages with a rounded surface 123 such that the rod is continuously bearing against the lateral beam 15 even though the angle of the rod is being changed along with the pivoting of the set of legs 120. As each controller knob 18a, 18b is turned and tightened, a lower end of the associated hinge mechanism 16a, 16b, and with it the associated upper leg portion 19 of each pair of legs 120 attached thereto, is urged inwardly towards the horizontal beam 15. Thus, each pair of the legs 120 of the portable support device 100 may be adjusted inwardly or, with a converse action, outwardly from the horizontal beam 15 independent of the other pair, thereby accommodating different surface conditions that may be present at various locations selected for use and also accommodating users with different body widths who wish to use the portable support device 100. In this implementation, the legs 120 can be fixed in a particular inward or outward orientation as a result of user manipulation of the controller knobs 18a, 18b. As such, the device 1 can be positioned into a desired configuration that affords the greatest stability and the legs 120 are then fixed in the desired position as selected by the user.

In other embodiments, other mechanisms may be used for allowing the legs of the portable support device 100 to be adjusted into a variety of independently angular relationships with respect to the horizontal beam 15 and the vertical posts 8a, 8b. For example, the legs may be adjustably connected to the portable support device 100 using ball joints or other suitable hardware connections as well as other threaded or non-threaded implementations.

Also, as depicted in FIG. 3, non-skid, non-scratch leg tips 22 made of rubber or other suitable material may be affixed to the lower leg portions 20 in order to enhance the stability of the lower leg portions 20 as they are positioned to support the portable support device 100 and its load.

FIG. 4 depicts a side view of one embodiment of the portable support device with its tiltable support board 1 in a tilted position. The elastic strap 4 and attached hooks 6 are viewable, hanging down behind the tiltable support board 1. FIG. 4 presents a clearer side view of a vertical post 8b and one embodiment of mechanisms used to secure the tiltable support board 1 in a variety of positions. As shown, the end 7b of the axle protrudes through an opening in the gear wheel 9, to which the end 7b of the axle is immovably attached. Thus, when the gear wheel 9 rotates, the axle rotates as well, making the tiltable support board 1 rotatable.

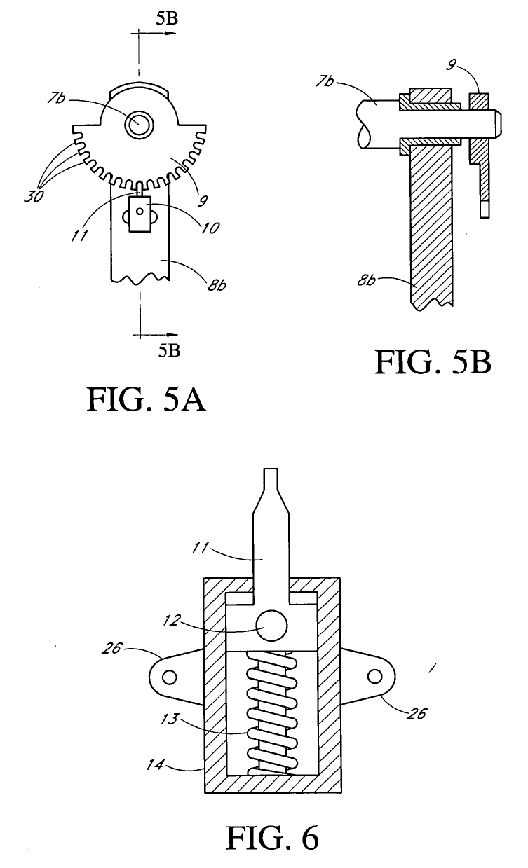

Below the gear wheel 9 on the vertical post 8b is a position-locking mechanism 10 that engages with the gear wheel 9, as will be described in greater detail with reference to FIGS. 5A, 5B, and 6, to lock the tiltable support board 1 into a desired position.

FIG. 5A provides a more detailed front view of one embodiment of the gear wheel 9 and the position-locking mechanism 10. As depicted in FIG. 5A, the gear wheel 9 includes a semi-circular shape with a plurality of teeth 30 formed or cut around the circumference of the semi-circular shape. The position-locking mechanism 10 includes a locking pin 11 that is configured to engage with the teeth 30 of the gear wheel 9, thereby obstructing rotation on the part of the gear wheel 9 and, in turn, obstructing rotation on the part of the tiltable support board 1, which is attached to the gear wheel 9.

FIG. 5B provides a more detailed cross-section view of one embodiment of the gear wheel 9 and the end 7b of the axle. In this embodiment, the end 7b of the axle can be seen to extend through an opening in the vertical post 8b and though an opening in the gear wheel 9, which is suspended in front of, but not attached to, the vertical post 8b.

FIG. 6 provides a more detailed view of the internal structure of one embodiment of the position-locking mechanism 10. As shown in FIG. 6, the position-locking mechanism 10 includes a shell 14 with an opening at the top and two tabs 26 that allow the position-locking mechanism 10 to be nailed, screwed, bolted, glued, or otherwise immovably affixed to the vertical post 8b. The shell 14 of the position-locking mechanism 10 houses a spring 13. A handle 12 has an inner portion located on top of the spring 13 in the shell 14 and a locking pin 11 that extends up through the opening in the shell. When the handle 12 is pulled downward, the locking pin 11 is accordingly pulled downward, thereby disengaging the locking pin 11 from the teeth 30 of the gear wheel 9. The gear wheel 9 is then free to be turned, and the tiltable support board 1 can be tilted to a desired degree of inclination. When the handle 12 is released, the spring 13 urges the locking pin 11 upwards to engage once again with the teeth 30 of the gear wheel 9, thereby holding the tiltable support board 1 in its current position.

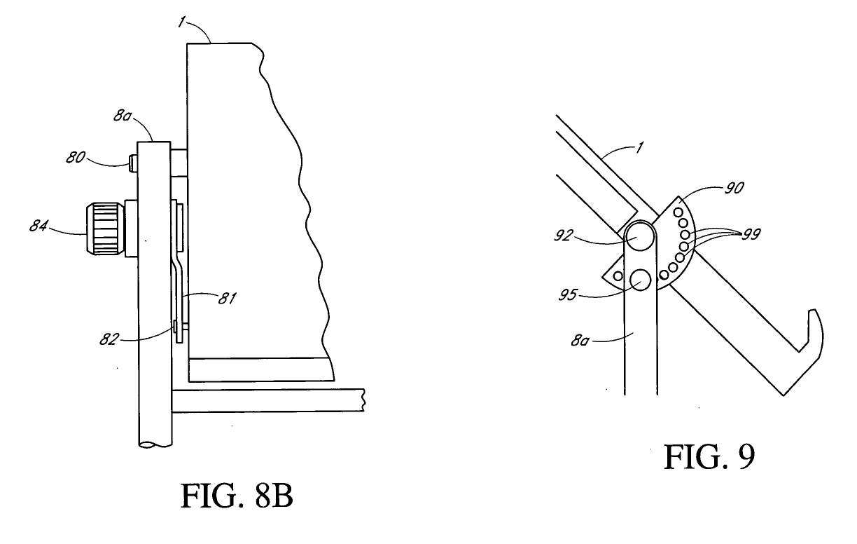

FIG. 8A provides a more detailed view of a second embodiment of a tilting mechanism for the tiltable support board 1 in a tilted position. As shown in FIG. 8A, an end of an axle 80 rotatably attaches the tiltable support board 1 and the vertical post 8a. Alternatively, another type of connector, including a connector that may not extend to the far side of the tiltable support board 1, rotatably attaches the tiltable support board 1 and the vertical post 8a. A slide bar 81 with an elongated slot 83 is also rotatably attached to the tiltable support board 1 at a connector point 82 at one end of the slide bar 81. The slide bar 81 is further connected to the vertical post 8a with an adjustable locking knob 84 that extends from a lateral side of the vertical post 8a, through the vertical post 8a, and through the slot 83 in the slide bar 81. It will be understood that the board 1 pivots with respect to the axle 80 as well as with respect to the axle 82 to ensure that the board 1 is tiltable. The adjustable locking knob 84 is configured to allow the slide bar 81 to move freely with respect to the vertical post 8a when the locking knob 84 is in an open position, and is configured to constrain the slide bar 81 from moving freely with respect to the vertical post 8a when the locking knob 84 is in an closed position. Thus, the locking knob 84 provides an alternative method for securely supporting the tiltable support board 1 in a selected position for use by a user while sitting, lying, reclining, or being situated in any of a variety of other body positions.

FIG. 8B provides a more detailed view of the second embodiment of a tilting mechanism for the tiltable support board 1 in a vertical position. The slide bar 81 is still attached to the tiltable support board 1 at the connector point 82 and to the back of the locking knob 84. The slide bar 81 is positioned in a vertical position, aligned with the vertical post 8a and with the tiltable support board 1 is also being held in a vertical position.

FIG. 9 provides a more detailed view of a third embodiment of a tilting mechanism for the tiltable support board 1. The third embodiment includes a gear wheel 90 that remains in a fixed position with respect to the tiltable support board 1 and that is able to rotate freely, when not constrained, with respect to a rotation point 92 on the vertical post 8a. The gear wheel 90 of FIG. 9 is semi-circular in shape and includes small holes 99 that are situated near a circumference of the semi-circular shape. A peg 95 or other protrusion can be extended through one of the small holes 99, thereby constraining the free rotation of the gear wheel 90 and the tiltable support board 1. The peg 95 or other protrusion can also be retracted from the small holes 99, thereby removing the constraint to free rotation.

From the foregoing, it will be appreciated that the device of the illustrated embodiment allows a user to make use of a computer while lying in a supine position in bed, on a couch or other surface. The independent adjustability of the legs 120, both in their length and also in their inward and outward pivoting from the platform 1, allow the user to position each of the four legs in a desired orientation such that the platform is stable when being used by the user. The user also has the ability to adjust the platform through a wide range of angles from the platform being generally parallel to the surface upon which the device is positioned to the platform being generally perpendicular or even orientated at an angle greater than perpendicular to the surface upon which the device is positioned. Hence, the user has great ability to position the platform, with an attached electronic device or book, in a specific desired orientation that provides the greatest comfort to the individual user.

Although certain embodiments and examples have been described herein, it will be understood by those skilled in the art that many aspects of the methods and devices shown and described in the present disclosure may be differently combined and/or modified to form still further embodiments. For example, in some embodiments additional features may be included to enhance the convenience and utility of the portable support device 100. For example, arm-rests, with or without associated mouse pads, and static or height-adjustable, may be included to allow a user's arms to be less likely to get tired while operating the laptop computer 115 or other electronic device. Additionally, it will be recognized that the methods described herein may be practiced using any device suitable for performing the recited steps. Such alternative embodiments and/or uses of the methods and devices described above and obvious modifications and equivalents thereof are intended to be within the scope of the present disclosure. Thus, it is intended that the scope of the present invention should not be limited by the particular embodiments described above, but should be determined only by a fair reading of the claims that follow.

What is claimed is:

1. An assembly for use with a portable electronic device, the assembly comprising:
a platform adapted to receive the portable electronic device;
a base structure wherein the platform is pivotally attached to the base structure so as to be rotatable through a plurality of angles; and
a plurality of legs attached to the base structure, wherein the plurality of legs are independently movable in at least two degrees of freedom so as to allow the user to independently position each of the legs in a desired orientation to thereby facilitate use of the portable electronic device on the assembly when the assembly is positioned on uneven surfaces.

2. The assembly of claim 1, wherein the platform is pivotable between an orientation wherein the platform is generally parallel to the surface upon which the assembly is positioned and an orientation wherein the platform is generally perpendicular to the surface upon which the assembly is positioned.

3. The assembly of claim 2, further comprising a securing mechanism for securing the platform in a desired orientation.

4. The assembly of claim 3, wherein the securing mechanism comprises a gear wheel that is attached to the platform so as to pivot therewith and a pin mechanism having a peg that is attached to the base, wherein the pin mechanism includes a member that can engage with the gear wheel to secure the platform in a desired orientation.

5. The assembly of claim 4, wherein the gear wheel is semi-circular in shape and includes a plurality of openings in its periphery that receive a peg of the pin mechanism to thereby inhibit the free rotation of the great wheel and the platform and wherein the pin mechanism can be manipulated to remove the peg from the opening to permit rotation of the gear wheel and platform.

6. The assembly of claim 3, wherein the securing mechanism comprises a slide bar with an elongated slot that is pivotally attached to the platform and the base structure and a adjustable locking knob that extends through the base structure and the elongate opening of the slide bar to thereby allow the securing member to pivot due to motion of the adjustable locking knob within the elongate slot and wherein tightening of the adjustable locking knob secures the platform in a desired orientation.

7. The assembly of claim 1, further comprising an assembly for securing the electronic device to the platform.

8. The assembly of claim 7, wherein the platform has an upper portion and a lower portion and wherein the assembly includes a strap that attaches to the upper portion so as to secure an upper portion of the portable electronic device to the platform and wherein the lower portion of the platform defines a lip that engages with the lower edge of the portable electronic device so that the lip in combination with the strap secure the portable electronic device to the platform.

9. The assembly of claim 8, wherein the lip is open to thereby accommodate different thicknesses of electronic devices.

10. The assembly of claim 9, wherein the platform is sized so as to receive a notebook or laptop computer.

11. The assembly of claim 1, wherein the plurality of legs are independently extendable along their length.

12. The assembly of claim 12, wherein the plurality of legs include a first portion that is attached to the base and a second portion that is telescopically attached to the upper portion so that the legs are extendable along their length.

13. The assembly of claim 1, wherein each of the pairs of the legs is independently pivotally with respect to the other pair connected to the base so as to be able to pivot inward and outward from the outer lateral edges of the base.

14. The assembly of claim 14, wherein the legs are attached to the base via a pivoting joint and also via an adjustment nut wherein the user can adjust the adjustment nut so as to position the legs at a desired pivotable orientation with respect to the base.

15. An assembly that allows a user to use a portable computer while the user is lying in a partially or totally supine position, the assembly comprising:
a platform having an upper portion and a lower portion and two lateral sides, wherein the platform is sized so as to receive a portable notebook or laptop computer;
a base, wherein the platform is pivotally attached to the base such that the platform can be pivoted and secured into a pivot orientation that facilitates use of the portable computer positioned on the platform with the user in a partially or totally supine position; and
a plurality of legs attached to the base wherein each of the legs are independently extendable along their lengths such that the plurality of legs can be adjusted to stabilize the platform when the assembly is being used on an uneven surface.

16. The assembly of claim 15 wherein the plurality of legs comprise two pair of legs and wherein each pair of legs is also independently pivotable with respect to the base and the other pair such that the legs can be positioned laterally outward from the base in a desired orientation

17. The assembly of claim 15, wherein the platform is pivotable between an orientation wherein the platform is generally parallel to the surface upon which the assembly is positioned and an orientation wherein the platform is generally perpendicular to the surface upon which the assembly is positioned.

18. The assembly of claim 17, further comprising a securing mechanism for securing the platform in a desired orientation.

19. The assembly of claim 18, wherein the securing mechanism comprises a gear wheel that is attached to the platform so as to pivot therewith and a pin mechanism that is attached to the base, wherein the pin mechanism includes a member that can engage with the gear wheel to secure the platform in a desired orientation.

20. The assembly of claim 19, wherein the gear wheel is semi-circular in shape and includes a plurality of openings in its periphery that receive a peg of the pin mechanism to thereby inhibit the free rotation of the great wheel and the platform and wherein the pin mechanism can be manipulated to remove the peg from the opening to permit rotation of the gear wheel and platform.

21. The assembly of claim 18, wherein the securing mechanism comprises a slide bar with an elongated slot that is pivotally attached to the platform and the base structure and a adjustable locking knob that extends through the base structure and the elongate opening of the slide bar to thereby allow the securing member to pivot due to motion of the adjustable locking knob within the elongate slot and wherein tightening of the adjustable locking knob secures the platform in a desired orientation.

22. The assembly of claim 15, further comprising an assembly for securing the electronic device to the platform.

23. The assembly of claim 22, wherein the platform has an upper portion and a lower portion and wherein the assembly includes a strap that attaches to the upper portion so as to secure an upper portion of the portable electronic device to the platform and wherein the lower portion of the platform defines a lip that engages with the lower edge of the portable electronic device so that the lip in combination with the strap secures the portable electronic device to the platform.
